(19) United States
(12) Patent Application Publication
(10) Pub. No.: US 2025/0065886 A1
(43) Pub. Date: Feb. 27, 2025

(54) INFORMATION PROCESSING DEVICE

(71) Applicant: TOYOTA JIDOSHA KABUSHIKI KAISHA, Toyota-shi (JP)

(72) Inventors: Shigeki MATSUMOTO, Nagoya-shi (JP); Naoya OKA, Nagakute-shi (JP); Hidetaka EGUCHI, Nagoya-shi (JP); Shigeru ICHIKAWA, Nagoya-shi (JP); Takeshi YAMADA, Nagoya-shi (JP); Masayo NAGAI, Nagoya-shi (JP); Ryosuke YAMAMOTO, Konan-shi (JP)

(73) Assignee: TOYOTA JIDOSHA KABUSHIKI KAISHA, Toyota-shi (JP)

(21) Appl. No.: 18/787,562

(22) Filed: Jul. 29, 2024

(30) Foreign Application Priority Data
Aug. 22, 2023 (JP) 2023-134500

(51) Int. Cl. B60W 40/09; B60W 40/08

(52) U.S. Cl. CPC B60W 40/09; B60W 2040/0809; B60W 2540/043

(57) ABSTRACT

In the information processing device, the control unit acquires, from the vehicle, vehicle data including traveling data of the vehicle and driver information of the vehicle. The control unit verifies the identity of the driver of the vehicle with a predetermined user associated with the vehicle based on the driver information included in the vehicle data. The control unit determines the validity of the traveling data included in the vehicle data according to the verification result of the identity between the predetermined user and the driver of the vehicle.

### CROSS-REFERENCE TO RELATED APPLICATION

This application claims priority to Japanese Patent Application No. 2023-134500 filed on Aug. 22, 2023, incorporated herein by reference in its entirety.

### BACKGROUND

### 1. Technical Field

The present disclosure relates to an information processing device.

### 2. Description of Related Art

There is known a technique in which an attribute of a user is analyzed based on information collected from a terminal of the user, and information corresponding to the analyzed attribute of the user is provided to the user (see Japanese Unexamined Patent Application Publication No. 2002-259440 (JP 2002-259440 A), for example).

### SUMMARY

An object of the present disclosure is to provide a technique capable of improving accuracy in collecting travel data on a vehicle.

One aspect of the present disclosure provides an information processing device. In that case, the information processing device includes, for example,
a control unit configured to: acquire travel data on a vehicle and vehicle data including driver information for the vehicle from the vehicle;
perform verification of identity of a predetermined user associated with the vehicle and a driver of the vehicle based on the driver information included in the vehicle data; and
determine validity of the travel data according to a result of the verification.

The present disclosure can also be regarded as an information processing method in which a computer executes processing of the information processing device. The present disclosure can also be regarded as an information processing program that causes a computer to execute the information processing method or a non-transitory storage medium that stores the information processing program.

According to the present disclosure, it is possible to provide a technique capable of improving accuracy in collecting travel data on a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a vehicle system according to an embodiment;

FIG. 2 is a block diagram illustrating an example of a configuration of each of an in-vehicle device and a server included in the vehicle system according to the embodiment;

FIG. 3 is a diagram illustrating an example of vehicle data according to the embodiment;

FIG. 4 is a diagram illustrating an example of information stored in the vehicle-management DB according to the embodiment; and

FIG. 5 is a diagram illustrating an example of a process executed by servers according to the embodiment.

### DETAILED DESCRIPTION OF EMBODIMENTS

In recent years, attempts have been made to use data (travel data) acquired while a vehicle is traveling. It is expected that various services can be provided by using the travel data collected from the vehicle as big data. On the other hand, there is a possibility that the traveling data includes information that may affect privacy protection by being associated with the driver. For this reason, an attempt is made to use the collected traveling data after obtaining the consent of a user (predetermined user) who has the ownership or usage right of the vehicle.

The driver of the vehicle is not necessarily a predetermined user. For example, a family or acquaintance of a given user may drive a vehicle. In such a case, the accuracy of the travel data collected from the vehicle may be impaired. As an example, when traveling data collected from a vehicle driven by a generation or gender user to which a predetermined user belongs is required, when traveling data is collected from a vehicle driven by a family or acquaintance of a generation or gender different from the predetermined user, traveling data that does not satisfy the requirement is collected. As a result, the accuracy of the collected travel data may be impaired. Therefore, it is necessary to secure the accuracy of the traveling data collected from the vehicle.

Therefore, in the information processing device according to the present disclosure, the control unit acquires vehicle data including the traveling data and the driver information from the vehicle. As an example, the traveling data may include data acquired while the vehicle is traveling, such as a position of the vehicle, a traveling speed of the vehicle, a traveling direction of the vehicle, a behavior of the vehicle, a departure point of the vehicle, a destination of the vehicle, a scheduled traveling route of the vehicle, a state of an in-vehicle device, and an image captured by an in-vehicle camera. Further, the driver information is information necessary for verifying the identity between a predetermined user and the driver, such as biological information of the driver of the vehicle and/or driving characteristics of the driver. The control unit may acquire the above-described vehicle data by communicating with a device mounted on the vehicle through a network.

The control unit verifies the identity between the predetermined user associated with the vehicle and the driver of the vehicle based on the driver information included in the vehicle data acquired from the vehicle. The predetermined user is a user who has agreed to use the travel data acquired from the vehicle driven by the predetermined user, and is, for example, a user who has ownership or usage rights of the vehicle. The verification of the identity between the driver and the predetermined user may be performed based on the biological information included in the driver information and/or the information indicating the driving characteristic. In this case, the information processing device may include a storage unit that holds biological information of a predetermined user and/or information indicating a driving characteristic in association with the vehicle. Then, the control unit may verify the identity between the driver and the predetermined user by collating the biological information included in the driver information and/or the information indicating the driving characteristic with the biological information stored in the storage unit and/or the information indicating the driving characteristic.

The control unit determines the validity of the traveling data included in the vehicle data according to the verification result of the identity between the driver and the predetermined user. As an example, in a case where the verification of the identity between the driver and the predetermined user is successful (for example, in a case where the verification of the biological information included in the driver information and/or the information indicating the driving characteristic and/or the biological information held in the storage unit and/or the information indicating the driving characteristic is successful), the control unit may determine that the traveling data included in the vehicle data is valid. On the other hand, when the verification of the identity between the driver and the predetermined user fails (for example, when the collation between the biological information included in the driver information and/or the information indicating the driving characteristic and the biological information held in the storage unit and/or the information indicating the driving characteristic fails), the control unit may determine that the data acquired from the vehicle is not valid.

According to the information processing device of the present disclosure, it is possible to determine whether or not the traveling data acquired by the traveling vehicle is data when a predetermined user is driving. Thus, for example, in a case where traveling data of a vehicle driven by a user of a generation or gender to which a predetermined user belongs is required, it is possible to collect only traveling data satisfying the request. As a result, the accuracy of the collected travel data can be ensured.

The information processing device according to the present disclosure may be a server connected to an apparatus mounted on a vehicle through a network. In this case, the processor of the server corresponds to the control unit. In addition, verification of the identity between the driver and the predetermined user and determination of the validity of the data may be performed by a vehicle (a device mounted on the vehicle). In this case, the vehicle may transmit only the data determined to be valid to a device outside the vehicle (for example, a server or the like) through the network.

Hereinafter, an embodiment of the present disclosure will be described with reference to the drawings. The hardware configuration, the module configuration, the functional configuration, and the like described in the following embodiments are not intended to limit the technical scope of the disclosure only thereto unless otherwise specified.

### Embodiment

Embodiments of the present disclosure will be described with reference to the drawings. In the present embodiment, an example in which the information processing device according to the present disclosure is applied to a vehicle system will be described. A vehicle system is a system that collects data necessary for providing a predetermined service from a vehicle.

### Overview of Vehicle System

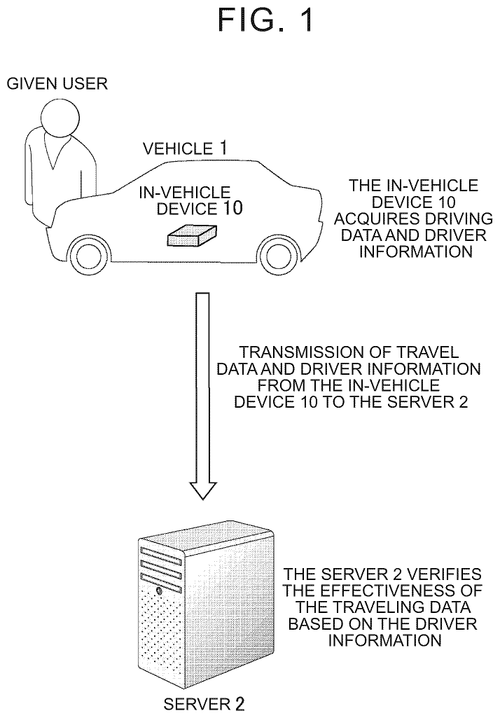

FIG. 1 is a diagram illustrating an outline of a vehicle system according to the present embodiment. The vehicle system according to the present embodiment includes an in-vehicle device 10 and a server 2 mounted on the vehicle 1. In the example illustrated in FIG. 1, only one in-vehicle device 10 (vehicle 1) is illustrated, but the vehicle system may include a plurality of in-vehicle devices 10 (vehicle 1).

The vehicle 1 is a probe vehicle for collecting traveling data. The vehicle 1 is a vehicle that can be driven by a predetermined user. The predetermined user is a user who has agreed to collect the traveling data in advance, and is, for example, a user who has an ownership right or a usage right of the vehicle 1. The in-vehicle device 10 has a function of collecting data (traveling data) of the vehicle 1 while traveling. The traveling data includes, for example, a position of the vehicle 1, a traveling speed of the vehicle 1, a traveling direction of the vehicle 1, a behavior of the vehicle 1, a departure point of the vehicle 1, a destination of the vehicle 1, a scheduled traveling route of the vehicle 1, a state of a device mounted on the vehicle 1, and a captured image of a camera mounted on the vehicle 1.

In addition to the above-described functions, the in-vehicle device 10 of the present embodiment has a function of acquiring information (driver information) of a driver of the vehicle 1. Further, the in-vehicle device 10 of the present embodiment has a function of generating vehicle data based on the traveling data and the driver information, and transmitting the generated vehicle data to the server 2. Here, the “driver information” is information used to verify the identity between the driver of the vehicle 1 and a predetermined user. In the present embodiment, the biological information of the driver is used as the driver information. The biometric information may be at least one of the driver's face, iris, pinna, voice print, palm shape, fingerprint, and the like.

The server 2 has a function of analyzing travel data included in vehicle data received from the in-vehicle device 10 and providing a predetermined service according to an analysis result. As an example, the server 2 generates the road traffic information by analyzing the position information and the speed information included in the travel data, and provides the generated road traffic information to another vehicle. As another example, the server 2 analyzes the destination or the scheduled traveling route included in the traveling data to generate tourist spot information around the destination or the scheduled traveling route, and provides the generated tourist spot information to the vehicle 1. The age and/or gender of a given user may be used to generate tourist spot information.

In addition to the above-described functions, the server 2 of the present embodiment also has a function of determining the validity of the traveling data. The validity of the traveling data is determined by a method of verifying the identity between the driver of the vehicle 1 and a predetermined user. The verification of the identity between the driver of the vehicle 1 and the predetermined user is performed based on the biological information included in the vehicle data. When the verification is successful, the server 2 determines that the traveling data is valid. When the verification fails, the server 2 determines that the traveling data is invalid. The server 2 performs the above-described analysis and the provision of the predetermined service by using the travel data determined to be valid. The travel data determined to be invalid may be discarded or used to provide a service other than a predetermined service.

The analysis of the traveling data and the provision of the predetermined service may be performed by an external device other than the server 2. In this case, the server 2 may provide only the travel data determined to be valid from the travel data collected from the vehicle 1 to the above-described external device.

### Configuration of Vehicle System

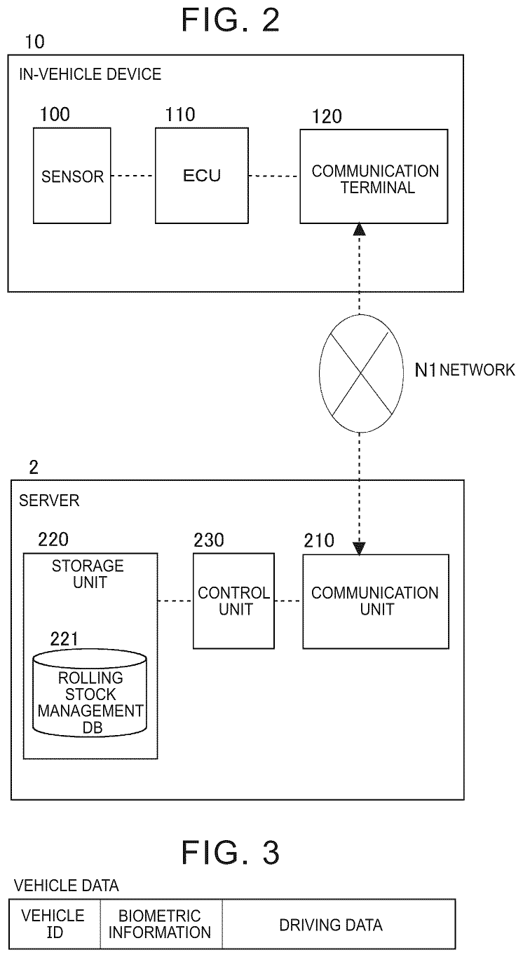

The configuration of the vehicle system will now be described with reference to FIG. 2. FIG. 2 is a block diagram illustrating an example of the configuration of each of the in-vehicle device 10 and the server 2 included in the vehicle system.

As illustrated in FIG. 2, the in-vehicle device 10 includes a sensor 100, an ECU 110, and a communication terminal 120. ECU 110 and the communication terminal 120 are connected to each other through an in-vehicle network based on a standard such as Controller Area Network (CAN), Local Interconnect Network (LIN), or FlexRay. Note that the configuration of the in-vehicle device 10 is not limited to the example illustrated in FIG. 2, and changes, additions, and omissions of constituent elements can be made as appropriate according to the embodiment.

The sensor 100 includes a sensor for detecting a position of the vehicle 1 (for example, a GPS receiver), a sensor for detecting a traveling speed of the vehicle 1 (for example, a vehicle speed sensor), a sensor for detecting a traveling direction of the vehicle 1 (for example, a gyro sensor), a sensor for detecting a behavior of the vehicle 1 (for example, an acceleration sensor), a sensor for detecting a condition of a device mounted on the vehicle 1 (for example, an accelerator operation amount sensor, a brake pedal sensor, a steering sensor, a winker switch, or the like), and a plurality of sensors such as a camera mounted on the vehicle 1. Further, the sensor 100 of the present embodiment includes a sensor for acquiring biometric information of the driver. The sensor for acquiring biometric information of the driver includes at least one of a camera for capturing a face of the driver, a scanner for reading an iris of the driver, a scanner for reading a shape of an auricle of the driver, a microphone for capturing a voice of the driver, a scanner for reading a fingerprint of the driver, and the like.

ECU 110 is a small computer that controls devices mounted on the vehicles 1 in response to a detected signal from the sensor 100. ECU 110 include a plurality of ECU, such as ECU for controlling prime movers, ECU for controlling batteries, ECU for controlling transmissions, ECU for controlling brakes, ECU for controlling lights (headlights, brake lights, winker lights, etc.), ECU for controlling car navigation systems, ECU for controlling multimedia equipment, ECU for controlling air conditioners, and ECU for controlling door lock equipment. ECU 110 of the present embodiment acquires travel data and biometric information from the sensor 100, the car navigation system, and the like, and transmits the acquired travel data and biometric information to the communication terminal 120. Such a process may be repeatedly executed at a predetermined cycle while the vehicle 1 is running (the ignition switch is in the ON state), or may be executed in response to a command from the communication terminal 120 that has received a request from the server 2.

The communication terminal 120 is a terminal that communicates with the servers 2 through a network N1. The network N1 is, for example, a worldwide public communication network such as the Internet and Wide Area Network (WAN). The network N1 may include a telephone communication network such as a mobile telephone and/or a radio communication network such as Wi-Fi. The communication terminal 120 of the present embodiment generates vehicular data using the traveling data and the biometric information received from ECU 110. FIG. 3 is a diagram illustrating an example of vehicle data according to the present embodiment. As illustrated in FIG. 3, the vehicle data in the present embodiment includes a vehicle ID, biometric information of a driver, traveling data, and the like. The vehicle ID is an identifier for individually identifying the vehicle 1 included in the vehicle system. The vehicle ID may be a vehicle body number of the vehicle 1, a character string marked on the vehicle registration number title, or a character string given when a predetermined user agrees to collect vehicle data. The vehicle ID may be an identifier (for example, a serial number or the like) of the in-vehicle device 10. Such vehicular ID is held in memories and the like of the communication terminal 120.

Referring back to FIG. 2, the server 2 includes a communication unit 210, a storage unit 220, and a control unit 230. Note that the configuration of the server 2 is not limited to the example illustrated in FIG. 2, and changes, additions, and omissions of constituent elements can be made as appropriate according to the embodiment.

The communication unit 210 is a communication interface for connecting the servers 2 to the network N1. The communication unit 210 includes, for example, a network interface board and/or a wireless communication interface for wireless communication.

The storage unit 220 is configured to include a main storage device (e.g., a RAM and a ROM) and an auxiliary storage device (e.g., an EPROM, HDD, a removable medium, and the like). In addition to Operating System (OS), the storage unit 220 of the present embodiment stores a program to be executed by a processor of the server 2, data to be used when the program is executed, and the like. Further, a vehicle-management DB 221 is constructed in the storage unit 220 of the present embodiment. The vehicle-management DB 221 is constructed by the processor of the server 2 executing the program of Database Management System (DBMS).

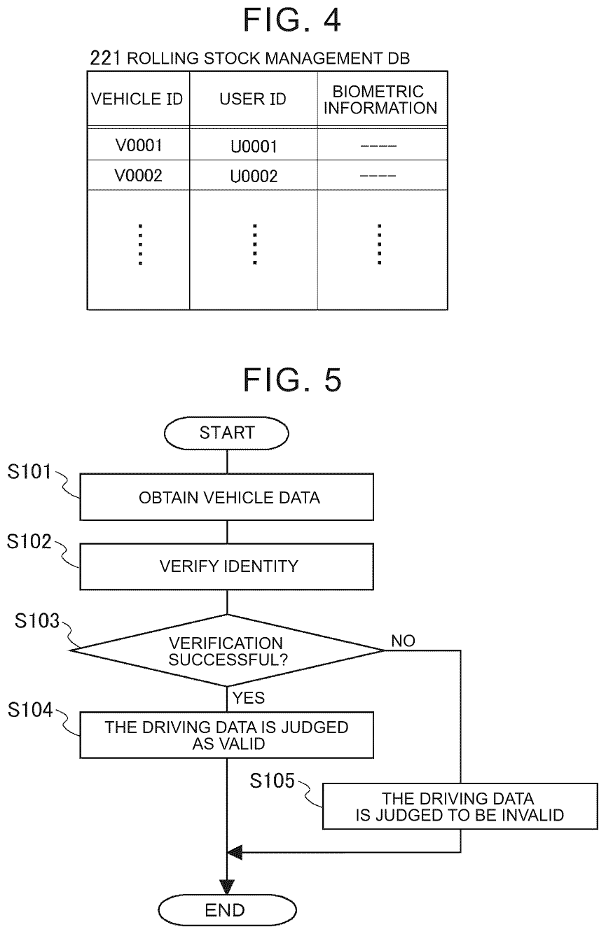

FIG. 4 is a diagram illustrating an example of information stored in the vehicle-management DB 221 according to the present embodiment. As illustrated in FIG. 4, the vehicle-management DB 221 according to the present embodiment holds a plurality of records corresponding to each of the plurality of vehicles 1 included in the vehicle system. Each record includes fields such as a vehicle ID, a user ID, and biometric information. Note that the configuration of the record held in the vehicle-management DB 221 is not limited to the example illustrated in FIG. 4, and the fields can be appropriately changed, added, and omitted according to the embodiment.

In the vehicle ID field, information (vehicle ID) for identifying each of the plurality of vehicles 1 included in the vehicle system is registered. In the user ID field, identifiers (user ID) of predetermined users corresponding to the vehicles 1 are registered. The user ID may be a name, nickname, email address, or telephone number of a given user. As another example, the user ID may be a character string arbitrarily assigned when a predetermined user agrees to collect vehicle data. In the biometric information field, biometric information (for example, at least one of a face, an iris, a pinna, a voice print, a palm shape, a fingerprint, and the like) of a predetermined user corresponding to each vehicle 1 is registered. The type of biometric information registered in the biometric information field can be changed in accordance with the type of biometric information detectable by the vehicle 1.

Referring back to FIG. 2, the control unit 230 of the server 2 is a software module realized by a processor such as a CPU or a GPU executing a program stored in the storage unit 220 (secondary storage device). The control unit 230 determines the validity of the traveling data included in the vehicle data by using the vehicle data transmitted from the in-vehicle device 10 as a trigger that the communication unit 210 has received the vehicle data. In determining the validity of the traveling data, first, the control unit 230 accesses the vehicle control ID included in the vehicle data as an argument to the vehicle-management DB 221, and specifies a record in which information matching the vehicle ID is registered in the vehicle ID field. Next, the control unit 230 reads out biometric information (biometric information of a predetermined user corresponding to the vehicle 1) registered in the biometric information field of the specified record. Then, the control unit 230 verifies the identity between the predetermined user and the driver of the vehicle 1 by collating the biological information of the predetermined user read from the vehicle-management DB 221 with the biological information (the biological information of the driver of the vehicle 1) included in the vehicle data. In a case where the collation between the biological information of the predetermined user and the biological information of the driver of the vehicle 1 is successful (in a case where the verification of the identity between the predetermined user and the driver of the vehicle 1 is successful), the control unit 230 determines that the travel data is valid. In addition, in a case where the collation between the biometric information of the predetermined user and the biometric information of the driver of the vehicle 1 fails (in a case where the verification of the identity between the predetermined user and the driver of the vehicle 1 fails), the control unit 230 determines that the traveling data is invalid.

When it is determined that the traveling data is valid, the control unit 230 analyzes the traveling data and provides a predetermined service. When it is determined that the traveling data is invalid, analysis of the traveling data and provision of a predetermined service are not performed. In this case, the driving data determined to be invalid may be discarded or used to provide other services.

### Processing Flow

### Process Flow

A processing flow executed by the server 2 in the present embodiment will be described with reference to FIG. 5. FIG. 5 is a flowchart illustrating a processing routine executed with the reception of the vehicle data transmitted from the in-vehicle device 10 by the communication unit 210 of the server 2 as a trigger. The execution subject of the processing routine of FIG. 5 is a processor of the server 2, and here, the functional components of the server 2 are described as the execution subject.

When the vehicle data transmitted from the in-vehicle device 10 is received by the communication unit 210 of the server 2, the control unit 230 acquires the vehicle data received by the communication unit 210 (S101). Upon completion of S101 process, the control unit 230 executes S102 process.

In S102, the control unit 230 verifies the identity between the driver of the vehicle 1, which is the source of the vehicle data, and a predetermined user corresponding to the vehicle 1. Specifically, the control unit 230 identifies a record in which information matching the vehicle ID is registered in the vehicle ID field by accessing the vehicle-management DB 221 using the vehicle ID included in the vehicle data acquired by S101 as an argument. The control unit 230 reads out biometric information (biometric information of a predetermined user) registered in the biometric information field of the specified record. The control unit 230 compares the biological information of the predetermined user with the biological information (the biological information of the driver of the vehicle 1) included in the vehicle data. Upon completion of S102 process, the control unit 230 executes S103 process.

In S103, it is determined whether or not the identity between the predetermined user and the driver has been successfully verified. When the comparison between the biological information of the predetermined user and the biological information of the driver is successful, the control unit 230 determines that the verification of the identity between the predetermined user and the driver is successful (affirmative determination in S103). On the other hand, when the collation between the biological information of the predetermined user and the biological information of the driver is a failure, the control unit 230 determines that the verification of the identity between the predetermined user and the driver is a failure (negative determination in S103).

When an affirmative determination is made on S103, the control unit 230 executes S104 process. In S104, the control unit 230 determines that the traveling data included in the vehicular data acquired by S101 is valid. On the other hand, when a negative determination is made in S103, the control unit 230 executes S105 process. In S105, the control unit 230 determines that the traveling data included in the vehicular data acquired by S101 is invalid.

When the control unit 230 finishes executing S104 or S105 processing, it finishes executing this processing routine.

### Operation and Effect of Embodiments

In the above-described embodiment, when the in-vehicle device 10 transmits the traveling data collected during the traveling of the vehicle 1 to the server 2, the biometric information of the driver is also transmitted to the server 2. Further, in the present embodiment, the storage unit 220 of the server 2 holds biological information of a predetermined user in a form associated with the vehicle 1. As a result, the control unit 230 of the server 2 can determine whether the driver of the vehicle 1 when the traveling data is collected is a predetermined user based on the biological information of the driver and the biological information of the predetermined user. As a result, for example, in a case where a predetermined service is provided by using travel data of the vehicle 1 driven by a user of a generation or gender to which a predetermined user belongs, it is possible to collect only travel data suitable for providing a predetermined service. Therefore, according to the present embodiment, it is possible to ensure the accuracy of the traveling data used for providing a predetermined service.

In the present embodiment, the server 2 corresponds to an “information processing device” according to the present disclosure. The control unit 230 of the server 2 corresponds to a “control unit” according to the present disclosure. Further, the storage unit 220 of the server 2 corresponds to a “storage unit” according to the present disclosure.

### Modified Examples

In the above-described embodiment, an example in which the biological information of the driver of the vehicle 1 is used as the driver information has been described. On the other hand, information indicating the driving characteristics of the driver of the vehicle 1 may be used as the driver information. Information indicating the driving characteristics of the driver (hereinafter, sometimes referred to as “characteristic information”) includes, for example, a seat position of the driver's seat of the vehicle 1, a turn-in-car operation time (time from when the turn-in-car switch is turned on until when the route change of the vehicle 1 is completed (the turn-in-car switch is automatically turned off)), a change amount of the accelerator operation amount per unit time, a change amount of the brake operation amount per unit time, or a time length from when the shift position is operated backward until when the vehicle 1 starts to retreat. Note that the characteristic information is not limited to the above-described example, and may be any information indicating a driving characteristic (such as a driving habit) of the driver.

When the above-described characteristic information is used as the driver information, the in-vehicle device 10 may collect the traveling data and the characteristic information while the vehicle 1 is traveling, and generate the vehicle data based on the collected traveling data and the characteristic information. The in-vehicle device 10 may generate vehicle data including the vehicle ID, the characteristic information (corresponding to the “second information” according to the present disclosure), and the traveling data, instead of the vehicle data described with reference to FIG. 3. In addition, the vehicle-management DB 221 of the server 2 may hold a record having a vehicle ID field, a user ID field, and a property data field instead of the record described with reference to FIG. 4. The characteristic information registered in the characteristic information field at that time is characteristic information of a predetermined user (corresponding to “first information” according to the present disclosure). Furthermore, the control unit 230 of the server 2 may verify the identity between the driver of the vehicle 1 and a predetermined user by collating the characteristic information included in the travel data with the characteristic information held in the vehicle-management DB 221.

According to the above-described modification, the same operation and effects as those of the above-described embodiment can be obtained. Note that both biological information and characteristic information may be used as the driver information. In this case, the control unit 230 of the server 2 may determine that the traveling data is valid only when both the collation of the biometric information and the collation of the characteristic information are successful. Accordingly, it is possible to further enhance the accuracy of the traveling data used for providing the predetermined service.

### Other Embodiments

The above-described embodiment is merely an example, and the present disclosure can be appropriately modified and implemented without departing from the gist thereof. For example, a part of the processing performed by the server 2 may be performed by the in-vehicle device 10. As an example, verification of the identity between the driver of the vehicle 1 and a predetermined user may be performed by the in-vehicle device 10. In this case, the in-vehicle device 10 may collect the traveling data and transmit the collected traveling data to the server 2 only when the verification of the identity between the driver of the vehicle 1 and the predetermined user is successful.

Also, the processes and the configurations described in the present disclosure can be appropriately combined to be implemented as long as no technical contradiction occurs. Moreover, the processes described as being executed by one device may be shared and executed by a plurality of devices. Alternatively, the processes described as being executed by different devices may be executed by one device. In the computer system, it is possible to flexibly change the hardware configuration for implementing each function.

What is claimed is:

1. An information processing device comprising a control unit configured to:
acquire travel data on a vehicle and vehicle data including driver information for the vehicle from the vehicle;
perform verification of identity of a predetermined user associated with the vehicle and a driver of the vehicle based on the driver information included in the vehicle data; and
determine validity of the travel data according to a result of the verification.

2. The information processing device according to claim 1, further comprising a storage unit that holds biological information on the predetermined user in association with the vehicle, wherein:
the driver information includes biological information on the driver; and
the verification of the identity of the predetermined user and the driver includes collating the biological information on the predetermined user with the biological information on the driver.

3. The information processing device according to claim 1, further comprising a storage unit that holds first information indicating a driving characteristic of the predetermined user in association with the vehicle, wherein:
the driver information includes second information indicating a driving characteristic of the driver; and
the verification of the identity of the predetermined user and the driver includes collating the first information with the second information.

4. The information processing device according to claim 1, wherein the control unit determines that the travel data are valid when the verification of the identity of the predetermined user and the driver has been successful.
